(19) United States
(12) Patent Application Publication
(10) Pub. No.: US 2026/0180439 A1
(43) Pub. Date: Jun. 25, 2026

(54) VOLTAGE REGULATOR CIRCUIT

(71) Applicant: Renesas Design (UK) Limited, Bourne End (GB)

(72) Inventors: Miroslav HUKEL, Ailing (DE); Eduardas JODKA, Freiburg (DE)

(73) Assignee: Renesas Design (UK) Limited, Bourne End (GB)

(21) Appl. No.: 18/988,821

(22) Filed: Dec. 19, 2024

(51) Int. Cl. H02M 3/07

(52) U.S. Cl. CPC H02M 3/07

(57) ABSTRACT

A circuit for converting an input voltage at an input port into one or more output voltages at corresponding output ports, the voltage regulator circuit comprising: a first switching device connected between a first node and the input port; a second switching device connected between a second node and the input port; a third switching device connected between a third node and the input port; a capacitive device connected between the first node and the second node; an inductive device connected between the second node and the third node; a fourth switching device connected between the first node and ground; a fifth switching device connected between the third node and the ground; and at least one of: at least one negative output rail connected between the first node and a first output port, and at least one positive output rail connected between the third node and a second output port.

The present disclosure relates to a voltage regulator circuit.

### BACKGROUND

It is commonly understood that there is a growing need to reduce both numbers and size of components in modern circuit boards, in order to provide ever smaller devices as well as to integrate additional features. Thus, it is desirable to provide an improved voltage regulator circuit which provides improved performance with fewer components.

In hybrid single inductor multiple output, SIMO, regulator circuits, the flying capacitor serves either the positive or the negative rails, resulting in significantly reduced inductor peak currents. The foregoing disclosure proposes an improved circuit that requires only a single flying capacitor which can serve both positive and negative rails in a hybrid mode.

### SUMMARY

According to a first aspect of the disclosure, there is provided a voltage regulator circuit for converting an input voltage at an input port into one or more output voltages at corresponding output ports, the voltage regulator circuit comprising: a first switching device connected between a first node and the input port; a second switching device connected between a second node and the input port; a third switching device connected between a third node and the input port; a capacitive device connected between the first node and the second node; an inductive device connected between the second node and the third node; a fourth switching device connected between the first node and ground; a fifth switching device connected between the third node and the ground; and at least one of: at least one negative output rail connected between the first node and a first output port, and at least one positive output rail connected between the third node and a second output port.

Optionally, wherein the third switching device is configured to switchably connect the capacitive device in series with the inductive device for the at least one negative output rail.

Optionally, wherein the first switching device is configured to switchably connect the capacitive device in series with the inductive device for the at least one positive output rail.

Optionally, wherein the first switching device in combination with the fifth switching device are configured to switchably connect the capacitive device in series with the inductive device between the input port and the ground in order to magnetize the inductive device using the capacitive element and the input voltage.

Optionally, wherein the third switching device in combination with the fourth switching device are configured to switchably connect the inductive device in series with the capacitive device between the input port and the ground in order to charge the capacitive device using the inductive device.

Optionally, wherein the second switching device in combination with the fourth switching device are configured to switchably connect the capacitive device between the input port and the ground in order to charge the capacitive device via the input voltage.

Optionally, wherein the second switching device, the fourth switching device, and the fifth switching device are used in combination to switchably and simultaneously connect the capacitive device and the inductive device between the input port and the ground in order to magnetize the inductive device and charge the capacitive device.

Optionally, wherein the fourth switching device and the fifth switching device are used in combination to switchably connect the capacitive device and the inductive device in series in order to magnetize the inductive device using the capacitive device.

Optionally, wherein operation of the voltage regulator circuit comprises a first phase;
wherein the first phase comprises charging the capacitive device.

Optionally, wherein the first phase comprises at least one of a first or second operation;
wherein during the first operation of the first phase the second and fourth switching device are switched on and the first, third, and fifth switching devices are switched off, such that the capacitive element is charged via the input voltage; or
wherein during the second operation of the first phase the third and fourth switching device are switched on and the first, second, and fifth switching devices are switched off, such that the capacitive element is charged via the input voltage and the inductive element.

Optionally, wherein the operation of the voltage regulator circuit comprises a second phase;
wherein the second phase comprises magnetizing the inductive device.

Optionally, wherein second phase comprises at least one of a first, second, or third operation;
wherein during the first operation of the second phase the second, fourth, and fifth switching devices are switched on, and the first and third switching devices are switched off, such that the capacitive device is charged via the input voltage at the same time as the inductive device is magnetized using the input voltage;
wherein, during the second operation of the second phase the fourth and fifth switching devices are switched on and the first, second, and third switching devices are switched off, such that the inductive device is magnetized using the capacitive device; and
wherein, during the third operation of the third phase the first and fifth switching device are switched on and the second, third, and fourth switching device are switched off, such that the inductive device is magnetized using the capacitive device and the input voltage.

Optionally, wherein the operation of the voltage regulator circuit comprises a third phase;
wherein the third phase comprises demagnetizing the inductive device.

Optionally, wherein the operation of the voltage regulator circuit comprises a fourth phase, wherein, during the fourth phase:
the third switching device is switched on and the first, second, fourth, and fifth switching devices are switched off, such that the inductor is demagnetized to charge the at least one negative voltage rail and the capacitive device; and
   the second and fourth switching devices are switched on, and the first, third, and fifth switching devices are switched off, such that the inductor is demagnetized to charge the at least one positive voltage rail and the capacitive device.

According to a second aspect of the disclose, there is provided a method of operating a voltage regulator circuit for converting an input voltage at an input port into one or more output voltages at corresponding output ports, the method comprising: connecting a first switching device between a first node and the input port; connecting a second switching device between a second node and the input port; connecting a third switching device between a third node and the input port; connecting a capacitive device between the first node and the second node; connecting an inductive device between the second node and the third node; connecting a fourth switching device between the first node and ground; connecting a fifth switching device between the third node and the ground; connecting at least one of: at least one negative output rail between the first node and a first output port; and at least one positive output rail between the third node and a second output port.

Optionally, further comprising a first predetermined operation sequence that is performed repeatedly to generate a positive output voltage that is larger than two times the input voltage, the first predetermined operation sequence comprising:
switching the third and fourth switching devices on, and switching the first, second, and fifth switching devices off;
switching the first and fifth switching devices on, and switching the second, third, and fourth switching devices off; and
switching the first switching device on, and switching the second, third, fourth, and fifth switching devices off.

Optionally, further comprising a second predetermined operation sequence that is performed repeatedly to generate a positive output voltage that is larger than the input voltage and smaller than two times the input voltage, the second predetermined operation sequence comprising:
switching the third and fourth switching devices on, and switching the first, second, and fifth switching devices off;
switching the first switching device on, and switching the second, third, fourth, and fifth switching devices off; and
switching the second and fourth switching devices on, and switching the first, third, and fifth switching devices off.

Optionally, further comprising a third predetermined operation sequence that is performed repeatedly to generate a negative output voltage that is larger than the input voltage, the third predetermined operation sequence comprising:
switching the third and fourth switching devices on, and switching the first, second, and fifth switching devices off;
switching the fourth and fifth switching devices on, and switching the first, second, and third switching devices off; and
switching the fifth switching device on, and switching the first, second, third, and fourth switching devices off.

Optionally, further comprising a fourth predetermined operation sequence that is performed repeatedly to generate a negative output voltage that is larger than zero and smaller than the input voltage, the fourth predetermined operation sequence comprising:
switching the third and fourth switching devices on, and switching the first, second, and fifth switching devices off;
switching the fifth switching device on, and switching the first, second, third, and fourth switching devices off; and
switching the third switching device on, and switching the first, second, fourth, and fifth switching devices off.

### BRIEF DESCRIPTION OF THE DRAWINGS

The disclosure is described in further detail below by way of example and with reference to the accompanying drawings, in which:

FIG. 1 is a circuit diagram representing a voltage regulator;

FIG. 2a is a circuit diagram showing an example first operation of a first phase of operation of the voltage regulator;

FIG. 2b is a circuit diagram showing an example of a second operation of a first phase of operation of the voltage regulator;

FIG. 3a is a circuit diagram showing an example of a first operation of a second phase of operation of the voltage regulator;

FIG. 3b is a circuit diagram showing an example of a second operation of a second phase of operation of the voltage regulator;

FIG. 3c is a circuit diagram showing an example of a third operation of a second phase of operation of the voltage regulator;

FIG. 4a is a circuit diagram showing an example of a first operation of a third phase of operation of the voltage regulator;

FIG. 4b is a circuit diagram showing an example of a second operation of a third phase of operation of the voltage regulator;

FIG. 5a is a circuit diagram showing an example of a first operation of a fourth phase of operation of the voltage regulator;

FIG. 5b is a circuit diagram showing an example of a second operation of a fourth phase of operation of the voltage regulator; and

FIG. 6 is a flowchart illustrating a method of operating a voltage regulator.

### DETAILED DESCRIPTION

The current disclosure relates to a voltage regulator circuit which improves upon conventional and hybrid circuits by requiring a single flying capacitor to serve both positive and negative rails while maintaining all benefits of previously known circuits.

In the current disclosure, the “voltage regulator circuit” may be a DC-DC voltage regulator, or single input multiple output, SIMO regulator.

In the current disclosure, any “switching device”, or “switching element” may be a transistor device, such as a MOSFET, or any other suitable switching device or element.

In the current disclosure, “connect” or “connected” refers to an electrical communication between two or more components either directly (for example, via wires) or indirectly. “Switchably connected” refers to an electrical connection that may be formed by turning a switch on and thus forming a connection between two or more components.

The figures show a specific configuration, but it should be understood that it is intended that the scope of the disclosure include minor changes to components and layout, such as replacements to components of similar function.

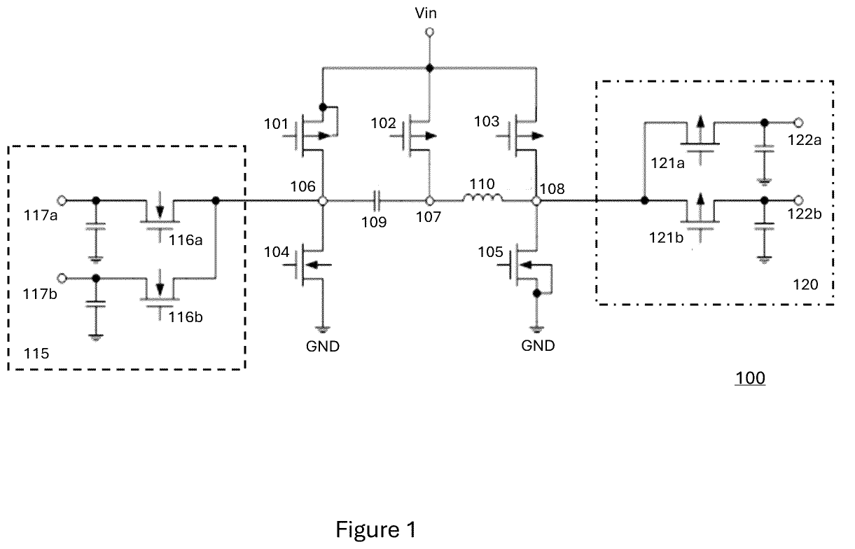

FIG. 1 shows a circuit diagram representing a voltage regulator circuit 100, such as a single inductor multiple output, SIMO, or DC-DC voltage regulator, for converting an input voltage at an input port, Vin, into one or more output voltages at corresponding output ports according to the current disclosure.

The voltage regulator circuit 100 comprises a first switching device 101 (for example, a transistor device such as a MOSFET) connected between a first node 106 and the input port, Vin; a second switching device 102 (for example, a transistor device such as a MOSFET) connected between a second node 107 and the input port, Vin; a third switching device 103 (for example, a transistor device such as a MOSFET) connected between a third node 108 and the input port, Vin; a capacitive device 109 (for example, a capacitor or any other suitable charge-storing device) connected between the first node 106 and the second node 107; an inductive device 110 (for example, an inductor or any other suitable device) connected between the second node 107 and the third node 108; a fourth switching device 104 (for example, a transistor device such as a MOSFET) connected between the first node 106 and ground, GND (for example, a reference voltage); a fifth switching device 105 (for example, a transistor device such as a MOSFET) connected between the third node 108 and the ground, GND; and at least one of: at least one negative output rail 115 connected between the first node 106 and at least one first output port, and at least one positive output rail 120 connected between the third node 108 and at least one second output port.

Although FIG. 1 shows two positive output rails and two negative output rails, it should be understood that this is merely exemplary. The voltage regulator circuit 100 may comprise both negative output rails 115 and positive output rails 120. In some examples, the voltage regulator circuit 100 may comprise a plurality of negative output rails 115 and a plurality of positive output rails 120. In other examples, the voltage regulator circuit 100 may comprise a plurality of negative output rails 115 or a plurality of positive output rails 120.

Each negative output rail 115 may comprise a low side switching device 116a, 116b (for example, a transistor device such as a MOSFET) which may be coupled between the first node 106 and a first output port 117a, 117b.

Each positive output rail 120 may comprise a high side switching device 121a, 121b (for example, a transistor device such as a MOSFET) which may be coupled between the third node 108 and a second output port 122a, 122b.

The voltage regulator circuit 100 may further include a controller (not shown) for generating control signals for operating the switching devices.

The operation of the voltage regulator circuit 100 is not illustrated here for the sake of conciseness, and is readily known or understandable to a person skilled in the art.

The operation of the voltage regulator circuit 100 may comprise several phases, wherein each phase represents a different switching configuration such that different actions may be performed by the circuit. For example, the phases may comprise charging the capacitive device; magnetizing the inductive device; and demagnetizing the inductive device, as well as charging the positive and negative output rails. In addition, each phase may comprise one or more of a set of operations. For example, the capacitive device may be charged in more than one way, so a corresponding phase may comprise one or more operations to be selected from. The different operations of the different phases may be achieved by performing specific switching patterns for the switching devices. For example, there may be up to four phases, wherein each phase comprises at least one operation. These phases will now be discussed in more detail.

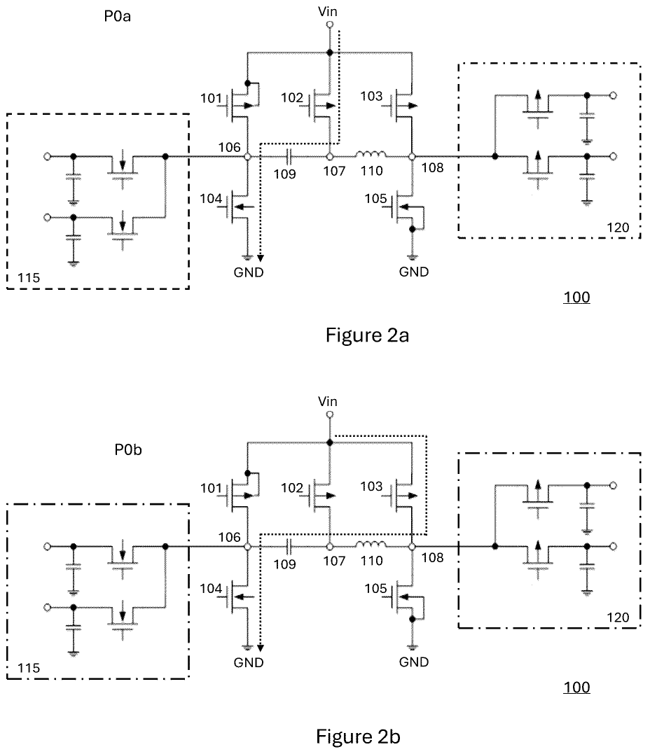

FIGS. 2a and 2b each represent an example of an operation of a first phase. The first phase may comprise charging the capacitive device 109.

FIG. 2a represents an example of a first operation in the first phase, which may be referred to as phase P0a. In this example, the capacitive device 109 is charged via the input voltage. This may be achieved by turning the second 102 and fourth 104 switching devices on and turning the first 101, third 103, and fifth 105 switching devices off.

That is, the second switching device 102 in combination with the fourth switching device 104 are configured to switchably connect the capacitive device 109 between the input port, Vin, and the ground, GND in order to charge the capacitive device 109 via the input voltage.

FIG. 2b represents an example of a second operation in the first phase, which may be referred to as phase P0b. In this example, the capacitive device 109 is charged via the input voltage and the inductive device 110. This may be achieved by turning the third 103 and fourth 104 switching devices on and turning the first 101, second 102, and fifth 105 switching devices off.

In more detail, the third switching device 103 in combination with the fourth switching device 104 are configured to switchably connect inductive device 110 in series with the capacitive device 109 between the input port, Vin, and the ground, GND in order to charge the capacitive device 109 using the inductive device and the input voltage.

This enables the capacitive device (for example, a flying capacitor) to be charged via the inductive device while significantly reducing inductor voltage ringing by reusing remaining energy in the inductive device.

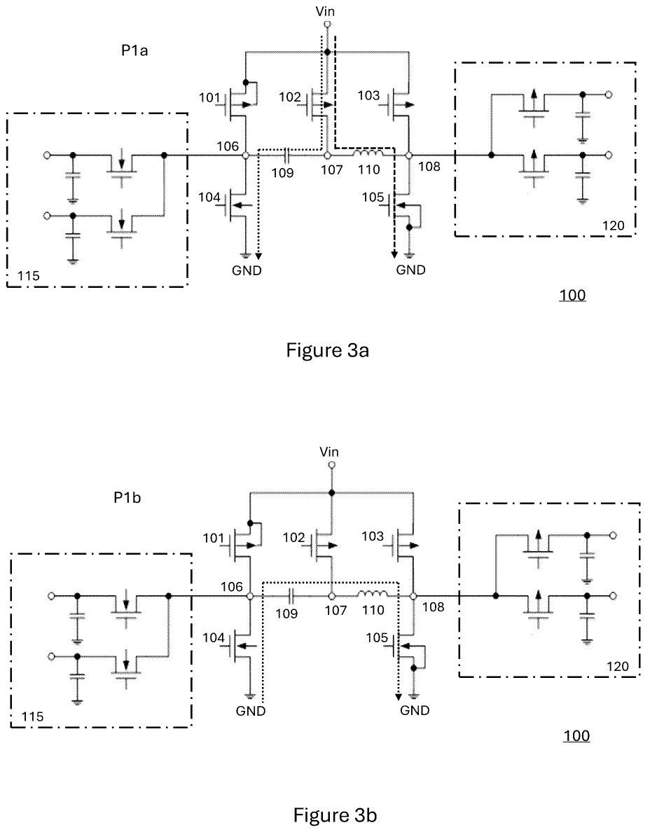

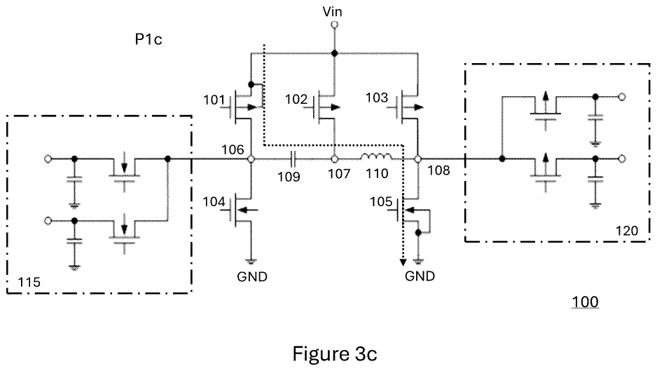

FIGS. 3a to 3c each represent an example of an operation of a second phase. The second phase may comprise magnetizing the inductive device 110.

FIG. 3a represents an example of a first operation in the second phase, which may be referred to as phase P1a. In this example, the inductive device 110 is magnetized and the capacitive device 109 is charged. This may be achieved by turning the second 102, fourth 104, and fifth 105 switching devices on and turning the first 101 and third 103 switching devices off.

In more detail, during the first operation of the second phase, the second 102, fourth 104, and fifth 105 switching devices are switched on, and the first and third switching devices are switched off, such that the capacitive device is charged via the input voltage at the same time as the inductive device is magnetized using the input voltage.

That is, the second switching device 102, the fourth switching device 104, and the fifth switching device 105 are used in combination to switchably and simultaneously connect the capacitive device 109 and the inductive device 110 between the input port, Vin, and the ground, GND, in order to magnetize the inductive device (via the input voltage) and charge the capacitive device (via the input voltage).

FIG. 3b represents an example of a second operation in the second phase, which may be referred to as phase P1b. In this example, the inductive device 110 is magnetized and the capacitive device 109 is discharged. This may be achieved by turning the fourth 104, and fifth 105 switching devices on and turning the first 101 and third 103 switching devices off.

In more detail, during the first operation of the second phase, the fourth 104 and fifth 105 switching devices are switched on and the first 101, second 102, and third 103 switching devices are switched off, such that the inductive device is magnetized using the capacitive device.

That is, the fourth switching device 104, and the fifth switching device 105 are used in combination to switchably connect the capacitive device 109 and the inductive device 110 in series in order to magnetize the inductive device 110 using the capacitive device 109. That is, by forming a current path between the inductive device 110 and the capacitive device 109, the capacitive device 109 is discharged, magnetizing the inductive device 110.

FIG. 3c represents an example of a third operation in the second phase, which may be referred to as phase P1c. In this example, the inductive device 110 is magnetized and the capacitive device 109 is discharged. This may be achieved by turning the first 101 and fifth 105 switching devices on and turning the second 102, third 103, and fourth 104 switching devices off.

In more detail, during the first operation of the second phase, the first 101 and fifth 105 switching devices are switched on and the second 102, third 103, and fourth 104 switching devices are switched off, such that the inductive device 110 is magnetized using the capacitive device 109 and the input voltage.

That is, the fourth switching device 104, and the fifth switching device 105 are used in combination to switchably connect the capacitive device 109 in series and the inductive device 110 in order to magnetize the inductive device 110 using the capacitive device 109 and the input voltage. That is, by forming a current path between the input port, Vin, the inductive device 110 and the capacitive device 109, the capacitive device 109 is discharged, magnetizing the inductive device 110 using both the charge of the capacitive device 109 and the input voltage.

This enables the inductive device 110 to be charged at a much faster rate by providing two times the input voltage across the inductive device 110. That is, by connecting the inductor between the input port, Vin, and ground, GND, in series with the flying capacitor, the voltage applied across the inductive device 110 is double the input voltage due to receiving voltage (equivalent to the input voltage) from the capacitive device 109 as well as from the input port, Vin.

This operation may be recommended for use when there is a large difference between the input voltage and the output voltage (for example, an V_{in_min} and V_{out_max}).

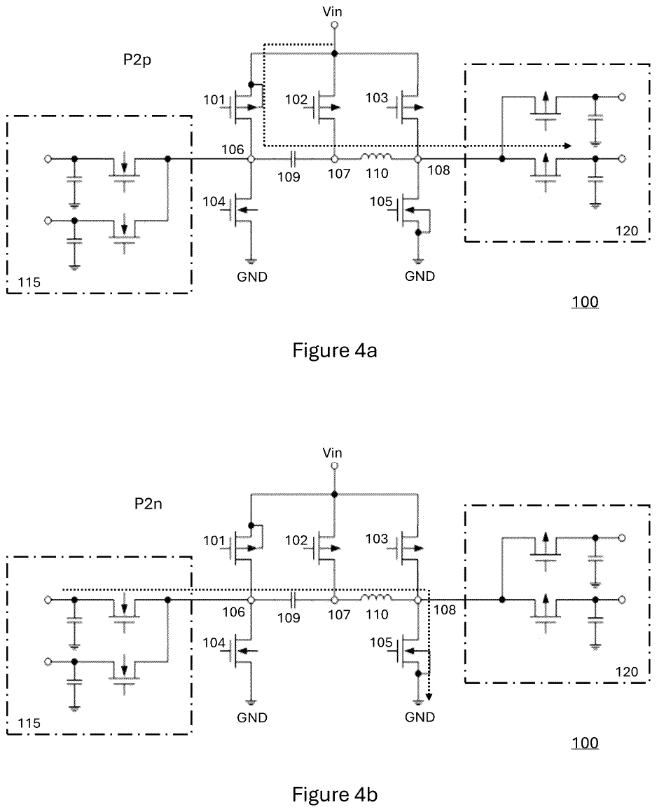

FIGS. 4a and 4b each represent an example of an operation of a third phase. The third phase may comprise demagnetizing and magnetizing the inductive device 110 in order to charge the negative output rails 115 or the positive output rails 120.

FIG. 4a represents an example of a first operation in the third phase, which may be referred to as phase P2p. In this example, the inductive device 110 is demagnetized, magnetized, and the at least one positive output rail 120 is charged. This may be achieved by turning the first 101 switching device on and turning the second 102, third 103, fourth 104, and fifth 105 switching devices off.

In more detail, during the first operation of the third phase, the first switching device 101 is switched on, and the second 102, third 103, fourth 104, and fifth 105 switching devices are switched off, such that the inductive device 110 is demagnetized to charge the at least one positive output rail 120. The inductive device 110 may also be magnetized by the input voltage received from the input port, Vin, in the case that the output voltage is less than two times the input voltage.

That is, the first switching device 101 is configured to switchably connect the capacitive device 109 in series with the inductive device 110 for the at least one positive output rail.

FIG. 4b represents an example of a second operation in the third phase, which may be referred to as phase P2n. In this example, the inductive device 110 is demagnetized, magnetized, and the at least one negative output rail 115 is charged. This may be achieved by turning the fifth 105 switching device on and turning the first 101, second 102, third 103, and fourth 104 switching devices off.

In more detail, during the second operation of the third phase, the fifth switching device 105 is switched on, and the first 101, second 102, third 103, and fourth 104 switching devices are switched off, such that the inductive device 110 is demagnetized to charge the at least one negative output rail 115. The inductive device 110 is also magnetized by current flowing from the at least one negative output rail 115 to the ground, GND.

That is, the fifth switching device 105 is configured to switchably connect the capacitive device 109 in series with the inductive device 110 for the at least one negative output rail.

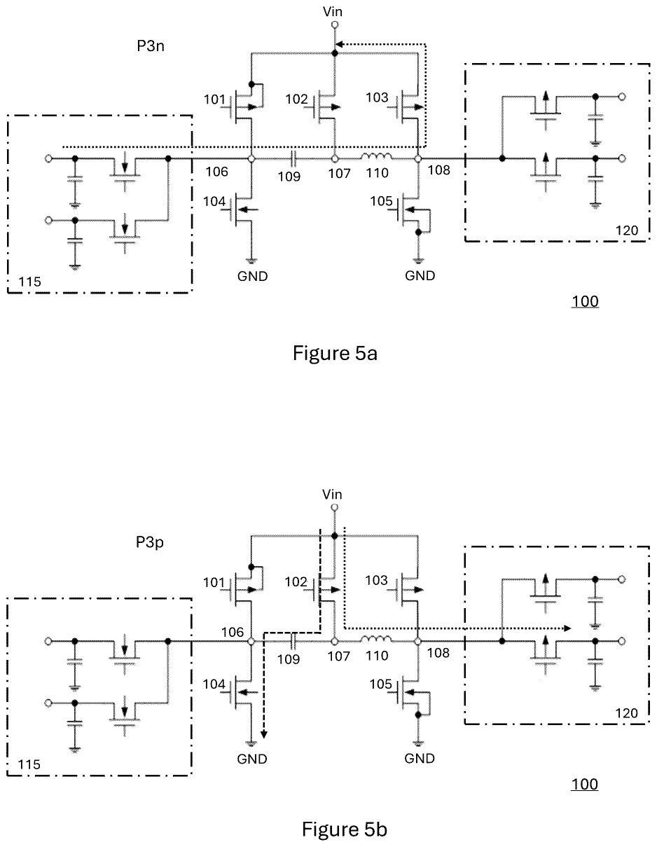

FIGS. 5a and 5b each represent an example of an operation of a fourth phase. The fourth phase may comprise demagnetizing the inductive device 110 in order to charge the negative output rails 115 or the positive output rails 120.

FIG. 5a represents an example of a first operation in the fourth phase, which may be referred to as phase P3n. In this example, the inductive device 110 is demagnetized, and the at least one negative output rail 115 is charged. This may be achieved by turning the third 103 switching device on and turning the first 101, second 102, fourth 104, and fifth 105 switching devices off.

In more detail, during the first operation of the fourth phase, the third switching device 103 is switched on, and the first 101, second 102, fourth 104, and fifth 105 switching devices are switched off, such that the inductive device 110 is demagnetized to charge the at least one negative output rail 120.

That is, the third switching device 103 is configured to switchably connect the capacitive device 109 in series with the inductive device 110 for the at least one negative output rail.

This operation enables the inductive device 110 to be demagnetized to charge the at least one negative voltage rail 115 to above zero.

FIG. 5b represents an example of a second operation in the fourth phase, which may be referred to as phase P3p. In this example, the inductive device 110 is demagnetized, and the at least one positive output rail 120 is charged. This may be achieved by turning the second 102 and fourth 104 switching devices on and turning the first 101, third 103, and fifth 105 switching devices off.

In more detail, during the second operation of the fourth phase, the second switching device 102 and the fourth switching device 104 are switched on, and the first 101, third 103, and fifth 105 switching devices are switched off, such that the inductive device 110 is demagnetized to charge the at least one positive voltage rail 120 and the capacitive device 109. Simultaneously, the capacitive device 109 is also charged via the input voltage.

That is, the second switching device 102 is configured to switchably and simultaneously connect the inductive device 110 to charge the at least one positive output rail and the capacitive device 109, as well as connecting the capacitive device 109 between the input port, Vin, and the ground.

This operation allows the at least one positive voltage rail 120 to be charged to a greater voltage than the input voltage.

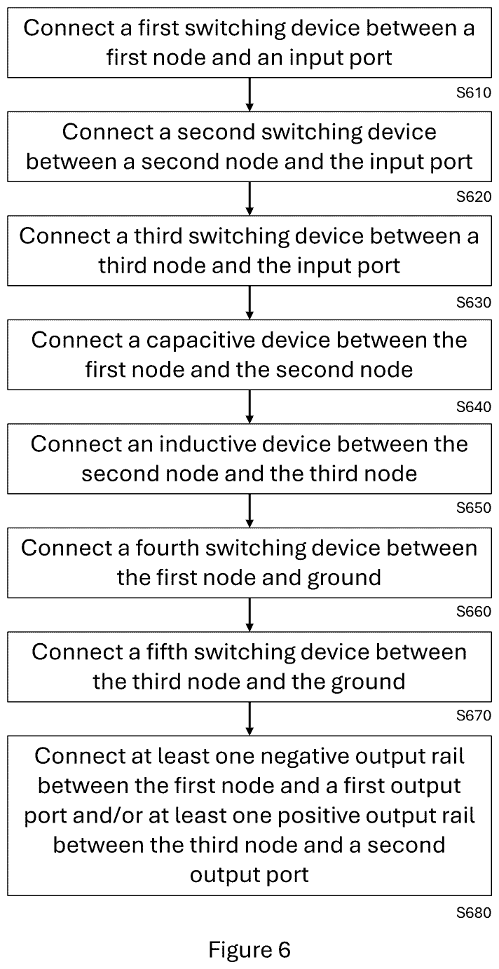

FIG. 6 is a flowchart representing a method of operating a voltage regulator circuit. For example, the voltage regulator circuit may be voltage regulator circuit 100 as illustrated by FIG. 1.

In step S610, a first switching device is connected between a first node and an input port.

In step S620, a second switching device is connected between a second node and the input port.

In step S630, a third switching device is connected between a third node and the input port.

In step S640, a capacitive device (such as a capacitor or any other suitable charge-storing device) is connected between the first node and the second node.

In step S650, an inductive device (such as an inductor or any other suitable device) is connected between the second node and the third node.

In step S660, a fourth switching device is connected between the first node and ground.

In step S670, a fifth switching device is connected between the third node and the ground.

In step S680, at least one negative output rail is connected between the first node and a first output port and/or at least one positive output rail is connected between the third node and a second output port.

As discussed above, the operation of the voltage regulator circuit may include different phases, wherein each phase, each phase may comprise one or more of a set of operations. It should be understood that the operations described above may be combined in various ways to create operation sequences to control the voltage regulator for different purposes. The operation sequences may be switching sequences which determine which switches are turned on and off at different points in time.

For example, in the case that the circuit is used for Pulse Frequency Modulation, PFM, the operation sequences may be configured such that between each PFM pulse a first phase is applied. That is, the capacitive device may always be charged between PFM pulses.

It should be understood that each operation and phase may be better suited to a different function of the circuit, and thus may be combined in a variety of ways depending on a desired outcome/purpose for the voltage regulator circuit. In addition, it should be understood that multiple operations of a given phase may be used in an operation sequence, and equally that no operations of a given phase may be used in an operation sequence.

Below are described four examples of predetermined operation sequences.

A first predetermined operation sequence may be performed repeatedly to generate a positive output voltage that is larger than two times the input voltage. The first predetermined operation sequence may comprise the following steps:
1. switching the third and fourth switching devices on, and switching the first, second, and fifth switching devices off;
2. switching the first and fifth switching devices on, and switching the second, third, and fourth switching devices off; and
3. switching the first switching device on, and switching the second, third, fourth, and fifth switching devices off.

When step 3 is completed, the sequence may be repeated.

The steps described above correspond to the second operation of the first phase (P0b), the third operation of the second phase (P1c), and the first operation of the third phase (P2p).

A second predetermined operation sequence may be performed repeatedly to generate a positive output voltage that is larger than the input voltage and smaller than two times the input voltage. The second predetermined operation sequence may comprise the following steps:
1. switching the third and fourth switching devices on, and switching the first, second, and fifth switching devices off;
2. switching the first switching device on, and switching the second, third, fourth, and fifth switching devices off; and
3. switching the second and fourth switching devices on, and switching the first, third, and fifth switching devices off.

When step 3 is completed, the sequence may be repeated.

The steps described above correspond to the second operation of the first phase (P0b), the first operation of the third phase (P2p), and the second operation of the fourth phase (P3p).

A third predetermined operation sequence may be performed repeatedly to generate a negative output voltage that is larger than the input voltage. The third predetermined operation sequence may comprise:
1. switching the third and fourth switching devices on, and switching the first, second, and fifth switching devices off;
2. switching the fourth and fifth switching devices on, and switching the first, second, and third switching devices off; and
3. switching the fifth switching device on, and switching the first, second, third, and fourth switching devices off.

When step 3 is completed, the sequence may be repeated.

The steps described above correspond to the second operation of the first phase (P0b), the second operation of the second phase (P1b), and the second operation of the third phase (P2n).

A fourth predetermined operation sequence may be performed repeatedly to generate a negative output voltage that is larger than zero and smaller than the input voltage. The fourth predetermined operation sequence may comprise the following steps:
1. switching the third and fourth switching devices on, and switching the first, second, and fifth switching devices off;
2. switching the fifth switching device on, and switching the first, second, third, and fourth switching devices off; and
3. switching the third switching device on, and switching the first, second, fourth, and fifth switching devices off.

When step 3 is completed, the sequence may be repeated.

The steps described above correspond to the second operation of the first phase (P0b), the second operation of the third phase (P2n), and the first operation of the fourth phase (P3n).

It should be understood that the above examples are merely exemplary and that the operations and phases discussed in the present disclosure are envisioned to be combined in a wide variety of ways, not limited to the above-given examples.

Various improvements and modifications can be made to the above without departing from the scope of the disclosure.

1. A voltage regulator circuit for converting an input voltage at an input port into one or more output voltages at corresponding output ports, the voltage regulator circuit comprising:
a first switching device connected between a first node and the input port;
a second switching device connected between a second node and the input port;
a third switching device connected between a third node and the input port;
a capacitive device connected between the first node and the second node;
an inductive device connected between the second node and the third node;
a fourth switching device connected between the first node and ground;
a fifth switching device connected between the third node and the ground; and
at least one of: at least one negative output rail connected between the first node and a first output port, and at least one positive output rail connected between the third node and a second output port.

2. The circuit of claim 1, wherein the third switching device is configured to switchably connect the capacitive device in series with the inductive device for the at least one negative output rail.

3. The circuit of claim 1, wherein the first switching device is configured to switchably connect the capacitive device in series with the inductive device for the at least one positive output rail.

4. The circuit of claim 1, wherein the first switching device in combination with the fifth switching device are configured to switchably connect the capacitive device in series with the inductive device between the input port and the ground in order to magnetize the inductive device using the capacitive element and the input voltage.

5. The circuit of claim 1, wherein the third switching device in combination with the fourth switching device are configured to switchably connect the inductive device in series with the capacitive device between the input port and the ground in order to charge the capacitive device using the inductive device.

6. The circuit of claim 1, wherein the second switching device in combination with the fourth switching device are configured to switchably connect the capacitive device between the input port and the ground in order to charge the capacitive device via the input voltage.

7. The circuit of claim 1, wherein the second switching device, the fourth switching device, and the fifth switching device are used in combination to switchably and simultaneously connect the capacitive device and the inductive device between the input port and the ground in order to magnetize the inductive device and charge the capacitive device.

8. The circuit of claim 1, wherein the fourth switching device and the fifth switching device are used in combination to switchably connect the capacitive device and the inductive device in series in order to magnetize the inductive device using the capacitive device.

9. The circuit of claim 1, wherein operation of the voltage regulator circuit comprises a first phase;
wherein the first phase comprises charging the capacitive device.

10. The circuit of claim 9, wherein the first phase comprises at least one of a first or second operation;
wherein during the first operation of the first phase the second and fourth switching device are switched on and the first, third, and fifth switching devices are switched off, such that the capacitive element is charged via the input voltage; or
wherein during the second operation of the first phase the third and fourth switching device are switched on and the first, second, and fifth switching devices are switched off, such that the capacitive element is charged via the input voltage and the inductive element.

11. The circuit of claim 1, wherein the operation of the voltage regulator circuit comprises a second phase;
wherein the second phase comprises magnetizing the inductive device.

12. The circuit of claim 11, wherein second phase comprises at least one of a first, second, or third operation;
wherein during the first operation of the second phase the second, fourth, and fifth switching devices are switched on, and the first and third switching devices are switched off, such that the capacitive device is charged via the input voltage at the same time as the inductive device is magnetized using the input voltage;
wherein, during the second operation of the second phase the fourth and fifth switching devices are switched on and the first, second, and third switching devices are switched off, such that the inductive device is magnetized using the capacitive device; and
wherein, during the third operation of the third phase the first and fifth switching device are switched on and the second, third, and fourth switching device are switched off, such that the inductive device is magnetized using the capacitive device and the input voltage.

13. The circuit of claim 1, wherein the operation of the voltage regulator circuit comprises a third phase;
wherein the third phase comprises demagnetizing the inductive device.

14. The circuit of claim 13, wherein the operation of the voltage regulator circuit comprises a fourth phase, wherein, during the fourth phase:
the third switching device is switched on and the first, second, fourth, and fifth switching devices are switched off, such that the inductor is demagnetized to charge the at least one negative voltage rail and the capacitive device; and
the second and fourth switching devices are switched on, and the first, third, and fifth switching devices are switched off, such that the inductor is demagnetized to charge the at least one positive voltage rail and the capacitive device.

15. A method of operating a voltage regulator circuit for converting an input voltage at an input port into one or more output voltages at corresponding output ports, the method comprising:
connecting a first switching device between a first node and the input port;
connecting a second switching device between a second node and the input port;
connecting a third switching device between a third node and the input port;
connecting a capacitive device between the first node and the second node;
connecting an inductive device between the second node and the third node;
connecting a fourth switching device between the first node and ground;
connecting a fifth switching device between the third node and the ground;
connecting at least one of: at negative output rail between the first node and a first output port; and at least one positive output rail between the third node and a second output port.

16. The method of claim 15, further comprising a first predetermined operation sequence that is performed repeatedly to generate a positive output voltage that is larger than two times the input voltage, the first predetermined operation sequence comprising:
switching the third and fourth switching devices on, and switching the first, second, and fifth switching devices off;
switching the first and fifth switching devices on, and switching the second, third, and fourth switching devices off; and
switching the first switching device on, and switching the second, third, fourth, and fifth switching devices off.

17. The method of claim 15, further comprising a second predetermined operation sequence that is performed repeatedly to generate a positive output voltage that is larger than the input voltage and smaller than two times the input voltage, the second predetermined operation sequence comprising:
switching the third and fourth switching devices on, and switching the first, second, and fifth switching devices off;
switching the first switching device on, and switching the second, third, fourth, and fifth switching devices off; and
switching the second and fourth switching devices on, and switching the first, third, and fifth switching devices off.

18. The method of claim 15, further comprising a third predetermined operation sequence that is performed repeatedly to generate a negative output voltage that is larger than the input voltage, the third predetermined operation sequence comprising:
switching the third and fourth switching devices on, and switching the first, second, and fifth switching devices off;
switching the fourth and fifth switching devices on, and switching the first, second, and third switching devices off; and
switching the fifth switching device on, and switching the first, second, third, and fourth switching devices off.

19. The method of claim 15, further comprising a fourth predetermined operation sequence that is performed repeatedly to generate a negative output voltage that is larger than zero and smaller than the input voltage, the fourth predetermined operation sequence comprising:
switching the third and fourth switching devices on, and switching the first, second, and fifth switching devices off;
switching the fifth switching device on, and switching the first, second, third, and fourth switching devices off; and
switching the third switching device on, and switching the first, second, fourth, and fifth switching devices off.
